(19) United States
(12) Patent Application Publication
(10) Pub. No.: US 2009/0130272 A1
(43) Pub. Date: May 21, 2009

(54) Use of nitrous oxide (N2O) or of a gas mixture containing nitrous oxide as sweetening agent for food products

(76) Inventors: Jacques Cutayar, Guyancourt (FR); Jean-Louis Pean, Montlhery (FR)

Correspondence Address: AIR LIQUIDE;Intellectual Property, 2700 POST OAK BOULEVARD, SUITE 1800, HOUSTON, TX, 77056, US

(21) Appl. No.: 10/569,361

(22) PCT Filed: Feb. 9, 2006
(86) PCT No.: PCT/FR06/50115

§ 371 Date: Jul. 15, 2008

(51) Int. Cl. A23L 1/236

(52) U.S. Cl. 426/319; 426/548

(57) ABSTRACT

A process for the manufacture of a product, in particular a food product, comprising a step of adding an agent with sweetening power, characterized in that the agent with sweetening power is made entirely or partly by the incorporation, into the product, of a gas or a gaseous mixture containing nitrous oxide N₂O.

The invention relates to the field of sweetening of products, in particular food products, or of pharmaceutical products, in particular drinks.

It is known that, in this industry, this is generally referred to as “sweetening”, regardless of the agent added, “true” sugar (sucrose) or sweetener as present on approved lists; this is also sometimes referred to as the addition of a “sweetening agent”.

It is known that the sweetening power is the evaluation of the sweet character compared with sucrose.

More specifically, the sucrose power is taken as 1 (sometimes evaluated in base 100); if a product has a sweetening power of 50, it is then considered that this product is 50 times as sweet as sucrose.

Sweeteners generally have sweetening powers which range from 30 to 3000.

Technically, it can therefore be said that a sweetening agent is a compound having a sweetening power and free of energy. Reference is sometimes made to an intense sweetener when the sweetening power is 30 to 3000 times greater than sucrose. However, from the point of view of the regulations, “sweeteners” are clearly identified, are present on a regulatory list, and if a product is not on the list, it is not recognized as a sweetening additive by the regulations.

The food industry has been constantly trying to solve the following equation: eating for pleasure but also eating for well being. If the trends in consumption over a number of years are observed, it can be seen, unfortunately, that malnutrition increasingly affects the developed countries, the incidence of obesity, which was initially high in the United States, has never been as high in Europe and this phenomenon continues to develop.

Consumers have become used to consuming products in which sugar is a major component of the taste. The consumption of sugar per kg per year and per inhabitant has moreover also increased (sugar in the product but also sugar added by the consumer to these products on their own initiative). One of the main sugars involved is sucrose.

Accordingly, many measures have been taken to limit the consumption of sugar, both to combat overweight and also to limit the related diseases (diabetes, obesity). The regulations require, for example, labeling the fat and sugar contents of food products, and increasingly, industrialists, through innovative products, are promoting the Anglo Saxon concept of “well being”.

The use of sweeteners in food products has been authorized since January 1988. These substances are characterized by their sweetening power, indicating the quantity of sucrose used to reproduce an equivalent sweet taste. These substances may be of a very diverse nature (sugars, sugar alcohols, peptides, proteins and the like) and of very different sweetening powers. Said sweetening power may vary according to the concentration used.

The ideal sweetener has a high sweetening power, it is not expensive, should not have an unpleasant taste, should be stable during the entire shelf life of the product and has no harmful effect on the body quite obviously.

There may be mentioned here Aspartame, Acesulfame K, saccharin and its derivatives, and the like, with sweetening powers which may be as high as 350 times the sweetening power of sucrose.

Most sweeteners, whether they are synthetic or nonsynthetic, leave a longer impression on the sensory apparatus, hence the persistence of a prolonged sweet taste extending to a feeling of disgust. In addition, the complete elimination of sucrose in favor of the sweetener causes in general a loss of filler effect of the product in the mouth (less thickness, less fullness in the mouth during tasting). Moreover, some sweeteners are unstable (in the hot state, in an acid medium) or develop unpleasant tastes (bitterness, metallic taste). The cost also represents a major disadvantage for their use. It should be noted, finally, that some of them may be responsible for undesirable effects for the consumer: allergenic, toxic or even carcinogenic, and may be subject to maximum doses for use in products, or may even be banned in the formulation of certain products intended in particular for unweaned babies.

It can therefore be seen that there is no ideal sweetener.

One of the objectives of the present invention is therefore to provide a novel solution which makes it possible to sweeten food products by providing a technical solution to all or some of the disadvantages mentioned above.

As will be seen in greater detail below, the invention proposes the use of nitrous oxide N₂O or a gaseous mixture containing N₂O, as agent with sweetening power which can be used as ingredient for food products, in particular liquid products, in particular drinks.

As will also be seen below, tests carried out, mainly on drinks of the type including sodas, flavored mineral waters or milk-based products show unambiguously and in an extraordinarily surprising manner, that N₂O can be used as sweetening agent, it being possible for its sweetening power to reach, according to the conditions for use, the equivalent of 50 g sucrose/liter under normal conditions for use (P max for saturation at 3 atmospheres). If the desired sweetening power is greater than 40-50 g sucrose/liter, the N₂O will then be preferably combined with another sweetening source. In this case, synergies between the N₂O and the sweetening agent may vary according to the sugar/sweetener used.

Synergies of different intensity have been noted in this case between the N₂O, on the one hand, and the sucrose or the sweeteners, on the other hand, in particular with Aspartame.

It should be emphasized that nitrous oxide is commonly used in the food industry; it indeed appears as an additive which is generally accepted in all foodstuffs under the code E942, sometimes with the following statement “propellant gas”, and among the known uses, there may therefore be mentioned the “propellant gas” effect (for example for products in a pressurized can such as whipped cream (crème chantilly)), the gases used for packaging products under a modified atmosphere (fruit and vegetables, preparation for pastries, and the like), the gases studied and sometimes used for producing overrun in food mousses or ice creams, and the like.

However, never was a sweetening power for products either mentioned or even suggested in the past.

The present invention therefore relates to a process for the manufacture of a product, in particular a food product, comprising a step of adding an agent with sweetening power, characterized in that the agent with sweetening power is made entirely or partly by the incorporation, into the product, of a gas or a gaseous mixture containing nitrous oxide N₂O.

By virtue of its sweetening power, and by virtue of its lack of energy, it can be considered that the gas or gaseous mixture containing nitrous oxide N₂O added according to the invention has the properties of a sweetening agent.

The process according to the invention may in fact adopt one or more of the following technical characteristics:
said gas consists of N₂O alone.
said gas consists of N₂O mixed with CO₂.
said gas consists of N₂O mixed with one or more gases authorized for use as ingredient for a food or pharmaceutical product.
the sweetening agent is only partly made by incorporating into the product said gas or gaseous mixture by virtue of the fact that a traditional sweetening agent is also incorporated into the product.
the traditional sweetening agent incorporated is a sugar or a sweetener or one of the mixtures thereof.
the product manufactured is a liquid.
the product manufactured is a drink.
the product manufactured is a milk drink.
the product manufactured is a soft product.
the product manufactured is a product with overrun.
the product manufactured is a solid product in which the gas or gaseous mixture containing the nitrous oxide is incorporated during one of the steps of its manufacture.

Other characteristics and advantages will emerge from the following description, detailing below numerous results of trials.

Case of a Flavored Soda-Type Drink

The evaluation of the sweetening power of N₂O was carried out through the following trials:
Evaluation of the sweetening of N₂O alone
Evaluation of the sweetening by N₂O+sucrose
Evaluation of the sweetening by N₂O+sucrose and N₂O+sweeteners

A flavored soda-type drink (carbonated at 3.5 to 4 g CO₂/liter—about 2 bar of CO₂ at 15° C.), served as carrier for the trials.

Evaluation of the Sweetening Power of N₂O Alone

Organization of the Trials
Drink with no supply of sugar
Drink saturated (at 10° C.) with N₂O/CO₂ mixtures at different pressures

Solubility of N₂O and CO₂ in the Drink in mg/l/bar:

| T° C. | CO₂ | N₂O |
|---|---|---|
| 5° C. | 2535 | 1895 |
| 10° C. | 2135 | 1575 |
| 15° C. | 1820 | 1325 |
| 20° C. | 1565 | 1125 |

Trials Carried Out

| Saturation pressure | % N₂O/CO₂ in the gaseous mixtures used | | | |
|---|---|---|---|---|
| (atmospheres) | 100 | 90/10 | 80/20 | 60/40 |
| 1 | | X | X | X |
| 2 | | X | X | X |
| 3 | | X | X | X |
| 4 | X | | | |
| 5 | | | X | |

Summary of the Results

The products were tasted by a sensory analysis panel:
The sweetening power of N₂O was clearly identified.
N₂O used alone has a high sweetening power but judged sometimes persistent or disgusting.
On the other hand, the N₂O+CO₂ combination is beneficial, the “salty” taste of CO₂ making it possible to advantageously reequilibrate the sweet profile of N₂O.
The desorption of N₂O alone is rapid in the form of large bubbles.
The product most liked is that, saturated as 3 bar absolute, of an 80% N₂O and 20% CO₂ mixture and for which the sweetening equivalent is estimated at about 30 g sucrose/liter.
The use of N₂O alone confers on the product a sweetening power evaluated at 40 g sucrose/liter.

Evaluation of the Sweetening Power of N₂O Combined with Sucrose

Organization of the Trials
Drink with no supply of sugar
Drink saturated (at 10° C.) according to the following matrix:

| | Control | Trial 1 | T2 | T3 | T4 | T5 |
|---|---|---|---|---|---|---|
| Sucrose (g/l) | 30 | 30 | 30 | 30 | 30 | 30 |
| % N₂O/CO₂ | 0/100 | 100/0 | 80/20 | 70/30 | 60/40 | 50/50 |
| gaseous | | | | | | |
| mixtures | | | | | | |
| Saturation | 3 | 3 | 3 | 3 | 3 | 3 |
| pressure in bar | | | | | | |
| absolute | | | | | | |

Summary of the Results

The products were tasted by a sensory analysis panel:
T2 and T3 are the products most liked, they exhibit a good compromise between sweetening intensity and balance, on the one hand, and the quality of desorption.
The sweetening is judged to be correct, slightly less than that of the standard product (sweetening control at 90 g of sucrose/l)
N₂O and sucrose have a synergistic effect; the product gasified at 3 bar of 80% N₂O-20% CO₂ mixture exhibits a sweetening evaluated at about 80 g/l of sucrose for a product containing only 30 thereof. The proportion of the sweetening provided by the N₂O is therefore evaluated at 50 g of sucrose/liter whereas it was evaluated at 30 g of sucrose/liter under the conditions of the preceding trial.

Evaluation of the Sweetening Power of N₂O Combined with Sweeteners

Trial set up to evaluate the sweetening effect of N₂O combined with sweeteners (Aspartame and Acesulfame K).

The sweetening powers of Aspartame and Acesulfame K are judged to be equivalent to 200.

A sweetening profile is characterized via 3 notes:
A top note
A body note
A tail note

Sucrose, Aspartame and Acesulfame K are complementary:
Aspartame has a high top note, the sweetening taste then decreases rapidly but exhibits great persistence after swallowing.
Sucrose has a dominant body note.
Acesulfame K is characterized by a strong tail note, associated with a metallic aftertaste

Organization of the Trials
Drink with no supply of sugar
Drink saturated (at 10° C.) according to the following matrix:

| | T1 | T2 | T3 | T4 | T5 | T6 |
|---|---|---|---|---|---|---|
| Sucrose (g/l) | 0 | 0 | 0 | 0 | 30 | 30 |
| Aspartame | 150 | 150 | 0 | 0 | 0 | 0 |
| (ppm) | | | | | | |
| Acesulfame K | 0 | 0 | 150 | 150 | 0 | 0 |
| (ppm) | | | | | | |
| % N₂O/CO₂ | 70/30 | 80/20 | 70/30 | 80/20 | 70/30 | 80/20 |
| gaseous | | | | | | |
| mixtures | | | | | | |
| Saturation | 3 | 3 | 3 | 3 | 3 | 3 |
| pressure in | | | | | | |
| bar absolute | | | | | | |

Summary of the Results

The products were tested by a sensory analysis panel:
The remarks made on the products containing sucrose are identical to those made during the preceding trial; the sweetening is again evaluated at about 80 g of sucrose/liter, slightly less than the standard sweetening (90 g of sucrose/liter).
In general, the products containing sweeteners are all judged to be more sweetened than normal. Their sweetening is evaluated at 110 g of sucrose/liter. The N₂O and sweetener combination therefore appears to exhibit an even greater synergy; the power of N₂O can, in this case, be estimated at 80 g of sucrose/liter for a product alone evaluated at 30 g of sucrose/liter during the preceding trial.
The 70/30 mixtures appear to be preferred for the product considered.
The N₂O/Aspartame combination appears to be preferred.
The use of N₂O combined with Aspartame in the complete absence of sucrose maintains the filler effect in the mouth (thickness and fullness in the mouth during tasting).

Other trials were performed on a flavored aerated mineral water and on unsweetened plain drinking yoghurt, both known for their high astringency during tasting. They are summarized below.

Flavored Mineral Water

Organization of the Trials

The water bottles are partially deaerated at 13° C. and reaerated with N₂O up to 2 bar (in other words they are partially deaerated so as to then reach, after the addition of N₂O, the desired CO₂/N₂O ratio).

The products provided for evaluation are the following:
T1: 0.5 b N₂O/1.5 b CO₂ (25% N₂O/75% CO₂)
T2: 1 b N₂O/1 b CO₂ (50% N₂O/50% CO₂)
T3: 1.5 b N₂O/0.5 b CO₂ (75% N₂O/25% CO₂)

Control: standard aerated mineral water aerated at 2 bar of CO₂.

Summary of the Results

The products were tasted by a sensory analysis panel (9 people), and a classification in order of preference (scores from 1 (greatly liked) to 4 (hardly liked)) was made.

| | | | | | | | | | | |
|---|---|---|---|---|---|---|---|---|---|---|
| Control | 1 | 1 | 3 | 4 | 2 | 2 | 4 | 1 | 1 = | 22 |
| T1 | 4 | 1 | 3 | 3 | 3 | 4 | 2 | 3 | 2 = | 25 |
| T2 | 2 | 1 | 2 | 2 | 1 | 1 | 1 | 2 | 1 = | 13 |
| T3 | 3 | 1 | 1 | 1 | 4 | 3 | 2 | 4 | 3 = | 22 |

The product aerated at 50% N₂O/50% CO₂ is clearly preferred to the original product. This preference is due to a sensation of sweetness which softens the astringency of the product.

The other two products are apparently not preferred to the original product:

Given that the first product (25% N₂O/75% CO₂) is not judged to be different by the tasters, it can be assumed that the quantity of N₂O is probably insufficient to modify the astringent character of the product.

The last one (75% N₂O/25% CO₂) is rejected, probably because of a problem of desorption of N₂O characterized by a sensation of swelling in the mouth. It is moreover judged to be “still” because it does not contain enough CO₂.

Unsweetened Plain Drinking Yoghurt

Organization of the Trials

The Products Provided are the Following:

| | Control | T1 | T2 | T3 | T4 |
|---|---|---|---|---|---|
| T° C. | 15° C. | 15° C. | 15° C. | 15° C. | 15° C. |
| Atmosphere | Air | Air | Air | N₂O | N₂O |
| Saturation | 0 | 1 | 1 | 1 | 1.8 |
| pressure in | | | | | |
| relative bar | | | | | |
| Sucrose (g/l) | 0 | 0 | 20 | 0 | 0 |

Summary of the Results

Here again, tasting of the products by a sensory analysis panel (9 people), and classification in order of preference (scores from 1 (greatly liked) to 5 (hardly liked)).

| | | | | | | | | | | |
|---|---|---|---|---|---|---|---|---|---|---|
| Control | 4 | 4 | 3 | 4 | 4 | 4 | 4 | 4 | 4 = | 34 |
| T1 | 2 | 3 | 4 | 3 | 2 | 3 | 4 | 3 | 3 = | 27 |
| T2 | 1 | 1 | 1 | 1 | 1 | 1 | 1 | 1 | 1 = | 9 |
| T3 | 2 | 2 | 2 | 2 | 2 | 2 | 2 | 2 | 2 = | 18 |

| | |
|---|---|
| T4 | PROBLEM OF FOAMING ON OPENING |

It is not desirable to exceed the saturation pressures of 2 bar.
The product containing sucrose is the most liked; the least liked is the unmodified product.
The sucrose-based product has a higher sweetening power than the product containing 1 bar of N₂O. The assay of sucrose was determined without knowing the solubility of N₂O in the yoghurt, that is to say without having been able to determine beforehand the sweetening power corresponding to a pressurization of 1 bar of N₂O.
The product at 1 bar of N₂O, however that may be, is preferred to the basic product and to the basic product aerated with air.
A slight overrun is liked.
The product was judged to have been made sweet compared with the original product by the use of N₂O.

Other additional trials, carried out on dessert products with overrun of the milk, neutral or flavored (vanilla for example) mousse type made it possible to confirm these features.

In summary, the examples detailed above made it possible to demonstrate unambiguously and in a completely novel manner for this industrial sector that N₂O possesses sweetening powers under chosen conditions of use, to be adapted of course to each product, some of which are presented by means of the present description.

The sweetening power of N₂O is demonstrated by substituting, depending on the cases, all or some of the sucrose.

It will, in some applications, be used in a useful manner in synergy with CO₂, or any other gas authorized for use as ingredient for food or pharmaceutical products or by the legislation for the relevant industry, which will make it possible both to reequilibrate the sweetening profile but also, in the case of drinks, to help in controlling its desorption, the proportions of both being variable depending on the products.

For high sweetening powers, it will be advantageously supplemented with sucrose or any other sweetening agent which persons skilled in the art may use in reduced proportions.

Synergistic effects of the N₂O/sucrose, and even more N₂O/sweetener, combination have been demonstrated.

In the complete absence of sugar, the added N₂O favorably compensates for the loss of filler in the product which retains its thickness and its fullness in the mouth.

In addition, used pure or as a mixture with CO₂ or any other gas authorized for use as ingredient according to the legislation for the relevant industry, N₂O sweetens the organoleptic profile of the product (bitterness, astringency and the like); in this case, it is possible to envisage bringing the saturation to 1 atmosphere or to even accept a slight overrun for the product.

1-13. (canceled)

14. A process for the manufacture of a product, in particular a food or pharmaceutical product, comprising a step of adding an agent with sweetening power, characterized in that the agent with sweetening power is made entirely or partly by the incorporation, into the product, of a gas or a gaseous mixture containing nitrous oxide N₂O.

15. The process for the manufacture of a product as claimed in claim 14, characterized in that said gas consists of N₂O alone.

16. The process for the manufacture of a product as claimed in claim 14, characterized in that said gas consists of N₂O mixed with CO₂.

17. The process for the manufacture of a product as claimed in claim 14, characterized in that said gas consists of N₂O mixed with one or more gases authorized for use as ingredient for a food or pharmaceutical product.

18. The process for the manufacture of a product as claimed in claim 15, characterized in that the sweetening agent is only partly made by incorporating into the product said gas or gaseous mixture by virtue of the fact that a traditional sweetening agent is also incorporated into the product.

19. The process for the manufacture of a product as claimed in claim 18, characterized in that the traditional sweetening agent incorporated is a sugar or a sweetener or one of the mixtures thereof.

20. The process for the manufacture of a product as claimed in claim 15, characterized in that the product manufactured is a liquid.

21. The process for the manufacture of a product as claimed in claim 20, characterized in that the product manufactured is a drink.

22. The process for the manufacture of a product as claimed in claim 20, characterized in that the product manufactured is a milk drink.

23. The process for the manufacture of a product as claimed in claim 15, characterized in that the product manufactured is a soft product.

24. The process for the manufacture of a product as claimed in claim 23, characterized in that the product manufactured is a product with overrun.

25. The process for the manufacture of a product as claimed in claim 15, characterized in that the product manufactured is a solid product in which the gas or gaseous mixture containing the nitrous oxide is incorporated during one of the steps of its manufacture.

26. A product obtained by claim 15.
